(19) United States
(12) Patent Application Publication
(10) Pub. No.: US 2025/0284610 A1
(43) Pub. Date: Sep. 11, 2025

(54) DIAGNOSTIC DETERMINATION

(71) Applicant: Repair Autopilot LLC, Las Vegas, NV (US)

(72) Inventors: Nicholas Erhart, Chaska, MN (US); Darren Schrader, Dundas, MN (US)

(73) Assignee: Repair Autopilot LLC, Las Vegas, NV (US)

(21) Appl. No.: 19/070,212

(22) Filed: Mar. 4, 2025

Related U.S. Application Data
(60) Provisional application No. 63/561,987, filed on Mar. 6, 2024.

(51) Int. Cl. G06F 11/32; G06F 9/451

(52) U.S. Cl. CPC G06F 11/321; G06F 9/453

(57) ABSTRACT

Examples of the present disclosure are directed towards determining a diagnosis of an appliance. In an example, a method for diagnosing an appliance includes receiving input indicating a type of an appliance, providing an initial prompt of an appliance guide; receiving second input indicating a condition of the appliance, determining a guidance path based on the second input and the type of appliance, and responsive to determining the guidance path, providing a first diagnostic interface.

### CROSS-REFERENCE TO RELATED APPLICATION(S)

This application claims priority to U.S. Provisional Application No. 63/561,987 entitled “DIAGNOSTIC DETERMINATION,” filed on Mar. 6, 2024, of which the entire disclosure is hereby incorporated by reference in its entirety.

### BACKGROUND

Repairing home appliances, such as ovens, laundry machines, dishwashers, heating, ventilation, and air conditioning (HVAC) systems, etc., can be time consuming and difficult. These difficulties arise from the varying specifications and parts that each appliance requires. For example, different types of ovens may require different heating elements. In addition, differing types of appliances can require different procedures in order to replace or repair the appliances. Accordingly, most consumers call a specialized repair service when an appliance malfunctions.

Given the many different types, brands, and models of appliances, learning how to properly diagnose and repair issues that occur in different appliances can be difficult and take significant time. Many companies release new appliances that have a different design from prior models. Thus, the new designs can require a different repair process. Furthermore, unfamiliar models of appliances can be more difficult upon which to diagnose issues on account of the unfamiliarity with the appliances.

These issues for diagnosing a broken appliance and determining a repair for an appliance present many problems. For example, it can be time-consuming and arduous to learn the repair process for every type of appliance. In addition, new technicians often struggle to diagnose and determine the appropriate repairs for unfamiliar appliances.

### SUMMARY

Embodiments of the disclosure are directed to a method for diagnosing an appliance, the method comprising: receiving, from a computing device, input indicating a type of an appliance; providing an initial prompt of an appliance guide to the computing device; receiving second input indicating a condition of the appliance from the computing device; a guidance path based on the second input and the type of the appliance, the guidance path including instructions to diagnose the appliance, the guidance path including one or more nodes that indicate steps for diagnosing the appliance based on the first input and the second input, wherein determining the guidance path includes determining potential paths through the nodes; and responsive to determining the guidance path, providing a first diagnostic interface to the computing device, the first diagnostic interface being associated with the guidance path.

In another aspect, an electronic computing system can comprise: a processor; and system memory, the system memory including instructions which, when executed by the processor, cause the electronic computing system to: receive, from a computing device, input indicating a type of an appliance; provide an initial prompt of an appliance guide to the computing device; receive second input indicating a condition of the appliance from the computing device; determine a guidance path based on the second input and the type of the appliance, the guidance path including instructions to diagnose the appliance, the guidance path including one or more nodes that indicate steps for diagnosing the appliance based on the first input and the second input, wherein determine the guidance path includes determine potential paths through the nodes; and responsive to a determination of the guidance path, provide a first diagnostic interface to the computing device, the first diagnostic interface being associated with the guidance path.

In yet another aspect, an example non-transitory computer readable medium can have instructions stored thereon, the instructions causing one or more processors to perform: receiving, from a computing device, input indicating a type of an appliance; providing an initial prompt of an appliance guide to the computing device; receiving second input indicating a condition of the appliance from the computing device; determining a guidance path based on the second input and the type of the appliance, the guidance path including instructions to diagnose the appliance, the guidance path including one or more nodes that indicate steps for diagnosing the appliance based on the first input and the second input, wherein determining the guidance path includes determining potential paths through the nodes; responsive to determining the guidance path, providing a first diagnostic interface to the computing device, the first diagnostic interface being associated with the guidance path; receiving third input from the computing device; responsive to receiving the third input, providing a second diagnostic interface to the computing device, the second diagnostic interface being associated with the guidance path; and providing a final diagnostic interface to the user, the final diagnostic including instructions to complete a diagnosis or repair of the appliance.

The details of one or more techniques are set forth in the accompanying drawings and the description below. Other features, objects, and advantages of these techniques will be apparent from the description, drawings, and claims.

### BRIEF DESCRIPTION OF THE DRAWINGS

Non-limiting and non-exhaustive examples are described with reference to the following figures.

FIG. 1 shows an example environment of a diagnostic determination system for providing appliance repair guides.

FIG. 2 shows example components of the diagnostic determination system of FIG. 1.

FIG. 3 shows an example appliance guide including guidance paths generated by the diagnostic determination system of FIG. 1.

FIG. 4A shows an example diagnostic interface associated with a guidance path as generated by the diagnostic determination system of FIG. 1.

FIG. 4B shows an additional example diagnostic interface generated by the diagnostic determination system of FIG. 1.

FIG. 5A shows a portion of an example appliance guide with associated diagnostic interfaces.

FIG. 5B shows an additional portion of the example appliance guide of FIG. 5A with associated diagnostic interfaces.

FIG. 5C shows an additional portion of the example appliance guide of FIG. 5A with associated diagnostic interfaces.

FIG. 5D shows an additional portion of the example appliance guide of FIG. 5A with associated diagnostic interfaces.

FIG. 5E shows an additional portion of the example appliance guide of FIG. 5A with associated diagnostic interfaces.

FIG. 5F shows an additional portion the example appliance guide of FIG. 5A with associated diagnostic interfaces.

FIG. 5G shows an additional portion of the example appliance guide of FIG. 5A with associated diagnostic interfaces.

FIG. 5H shows an additional portion of the example appliance guide of FIG. 5A with associated diagnostic interfaces.

FIG. 6 shows an example appliance guide for repairing a gas oven using the diagnostic determination system of FIG. 1.

FIG. 7 shows an example list of appliance guides that can be provided by diagnostic determination system of FIG. 1.

FIG. 8 shows an example method for diagnosing an appliance using the diagnostic determination system of FIG. 1.

FIG. 9 shows an example user interface for editing nodes and logic flows for an example appliance guide.

FIG. 10 shows example physical components of the diagnostic determination system of FIG. 1.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims.

As briefly described above, embodiments of the present disclosure are directed to a diagnostic determination system for providing diagnostic interfaces. Diagnostic interfaces can be used to guide a repair technician in repairing an appliance. Using the diagnostic determination system allows for repair technician to begin working substantially sooner than undergoing standard training procedures. For example, a normal training procedure may take three months or longer for a repair technician to begin going out on repair calls on their own. By using the diagnostic determination system, the repair technician can begin going on calls during their first week. Moreover, the diagnostic determination system also reduces misdiagnosis and increases efficiency of the repair.

The diagnostic determination system may be accessible through a mobile diagnostic application. For example, a technician has a mobile phone or tablet that can access the diagnostic application. A guidance path system is then accessed through the application. In some embodiments, the application begins with a login screen where the diagnostic determination system validates a user has access to the system. After validation, the system receives input indicating an appliance type (e.g., oven, HVAC, washing machine, etc.) subtype (e.g., electric or gas), and a condition indicating a malfunction type (e.g., the oven is not heating). The diagnostic determination system then provides a diagnosis interface. The diagnosis interface may include detailed instructions for providing additional input, such as written instructions or a video. The diagnosis interface may also be a part of a series of diagnosis interfaces that results in a final diagnostic. The final diagnostic provides a detail report on how to repair the appliance and resolve the issue. This final diagnostic may include written instructions or a video detailing how to complete the repair. Further, the final diagnostic may include a list of parts needed to complete the repair of the appliance. While certain appliance guides are discussed, the described system may include additional appliance guides for other appliance types. For example, appliance guides implemented as described below may also include appliance types such as computer repair, plumbing, automotive repair, garage door repair, small engine repair (e.g., snowblower, lawn mower, etc.) and other types of appliances and machines.

In some embodiments, the diagnostic application is configured to order the parts to complete the repair. For example, after determining a guidance path and final diagnostic, the diagnostic application orders the parts to complete the repair. In additional examples, the diagnostic application is configured to schedule a time for technician to complete a repair appointment. For example, a repair technician or a customer service representative may be on a sales call and need to schedule an appointment for the technician to go to a customer's house. Based on an indicated time or time available on the technician's calendar, the diagnostic application schedules a repair appointment. Scheduling the repair appointment includes sending confirmation of the appointment to a device of a customer.

In some examples, the diagnostic determination system receives input from a computing device. The computing device may be a computer, mobile phone, tablet, or other computing device. The diagnostic determination system provides an initial prompt of an appliance guide to the computing device. Second input indicating a condition of the appliance is received from the computing device. The diagnostic determination system determines a guidance path based on the second input and the type of appliance. The guidance path is a path through one or more logical based nodes that include associated instructions to diagnose the appliance. Further, the guidance path is determined based on received input about the status of the appliance. The instructions may be provided in a diagnostic interface. Responsive to determining the guidance path, the diagnostic determination system provides a diagnostic interface to the computing device. The diagnostic interface may be associated with a node of the guidance path.

Further, the diagnostic determination system may also receive additional input from the computing device. Responsive to receiving the additional input, the diagnostic determination system provides a second diagnostic interface to the computing device. The second diagnostic interface is associated with the guidance path. The guidance path may include branching paths depending on the received input. One branching path may be selected based on a determined condition of the appliance. Additional input may be received that indicates a status of the appliance.

In some embodiments, the computing device is caused to display the first diagnostic interface. The diagnostic determination system may also retrieve the guidance path from a guidance path database. The diagnostic determination system may also validate an account associated with a user. Validating the user's account may include receiving credentials and determining the credentials match a user account stored in an account database. In some embodiments, the diagnostic determination system provides a final diagnostic interface to the user. The final diagnostic interface includes instructions to complete a repair of the appliance. The final diagnostic also includes a list of parts needed to complete the repair of the appliance.

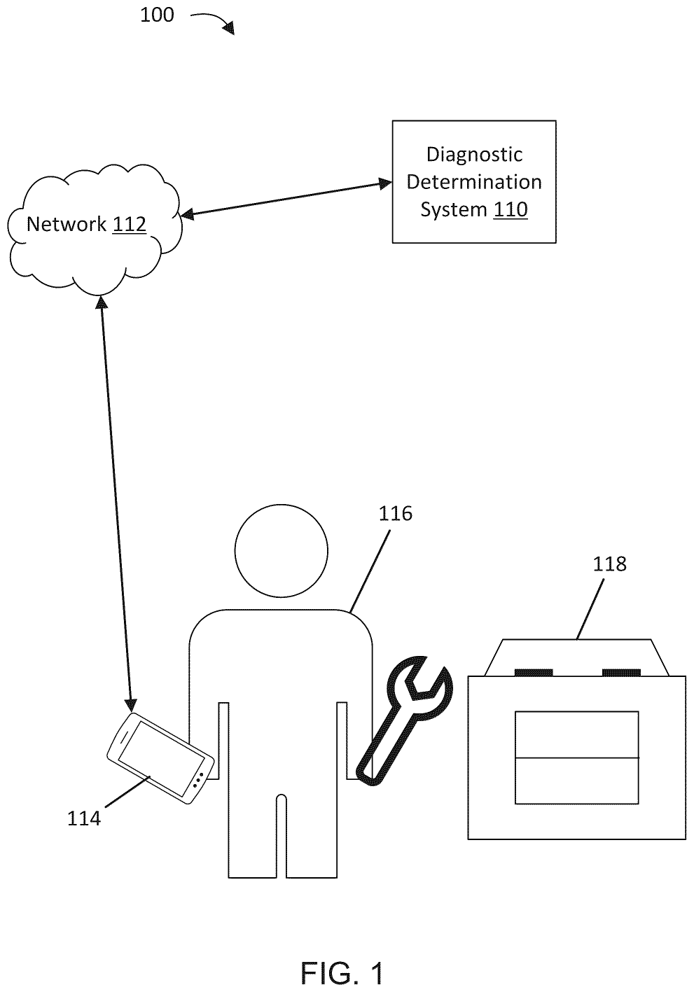

FIG. 1 shows an example environment 100 of a diagnostic determination system 110 for providing appliance repair guides. In some examples, the diagnostic determination system 110 connects through a network 112 to a computing device 114. The computing device 114 is used by a repair technician 116 to assist with diagnosing and/or repairing an appliance 118. In some examples, the diagnostic determination system 110 interacts with the computing device in an offline mode, in which case the diagnostic determination system 110 may be implemented within the computing device 114.

The diagnostic determination system 110 provides appliance guides and diagnostic interfaces to the computing device 114. These appliance guides instruct the repair technician 116 regarding how to repair the appliance 118. The appliance guides include one or more guides for issues of the specified appliance. For example, some guides may be associated with a sub-type of appliance. Other guides are associated with a particular issue exhibited by the appliance.

The computing device 114 is used to provide input to select a particular guide. Once the input is received, the computing device 114 transmits the input through the network 112 to the diagnostic determination system 110. The diagnostic determination system 110 is configured to determine a guidance path based on the received input and selected appliance guide. The guidance path is a sequence of steps to diagnose the appliance 118. The guidance path may also provide steps or instructions to repair the appliance 118. Guidance paths may update as input is continually received from computing device 114. The guidance paths also include associated diagnostic interfaces.

The diagnostic interfaces include instructions for the repair technician 116 to follow for a proper diagnosis or repair of the appliance 118. Further, the computing device 114 may include a mobile diagnostic application. This application is configured to interact with the diagnostic determination system 110. Further, the application is configured to operate on a device to cause the device to display the provided diagnostic interfaces and communicate with the diagnostic determination system 110.

As the diagnostic determination system 110 proceeds through the steps of the guidance path, the diagnostic determination system 110 provides a diagnosis of the appliance 118. The repair technician 116 can then follow the instructions included with the diagnostic interfaces to diagnose and/or repair the appliance 118. The described diagnostic determination system 110 enables technicians, such as repair technician 116, to expedite training for repair. For example, rather than having to spend weeks or months learning about a large number of appliances and appliance sub-types, a technician can be able to begin repairing the first week they are hired. Further, a repair company is able to enforce quality control much more efficiently.

A repair company using the diagnostic determination system 110 maintains repair quality and repair consistency through the guidance and diagnostic interfaces provided to technicians. Further, technicians can repair an appliance 118 by accessing the diagnostic determination system 110. The repair technician 116 can proceed through each diagnostic interface of a determined guidance path efficiently. Also, the diagnostic determination system 110 determines a more accurate diagnosis than traditional methods.

In some embodiments the computing device 114 is a smart phone. Other embodiments may include using a tablet as the computing device 114. Other devices, such as a laptop, may be used as well. Network 112 includes connections to many networks such as the Internet. Computing device 114 may connect wirelessly (such as over Wi-Fi, Bluetooth, or a cellular network) or a wired connection (such as Ethernet). Further, diagnostic determination system is shown as one component, but may be distributed over several computing devices, such as a central server, a database, or other computing system. In some embodiments, the computing device 114 accesses the diagnostic determination system 110 through an API.

In some embodiments, the computing device 114 can operate in an offline mode. The offline mode may include downloading one or more appliance guides and allowing access to the downloaded appliance guides for a predetermined time threshold. For example, the predetermined time threshold may be three hours. In some embodiments, the computing device 114 logs into an account that includes an associate license for accessing the diagnostic determination system 110. An additional computing device (not shown) may be able to log into the same account with the associated license. In some embodiments, the computing device 114 logs out of the account responsive to the additional computing device logging into the account.

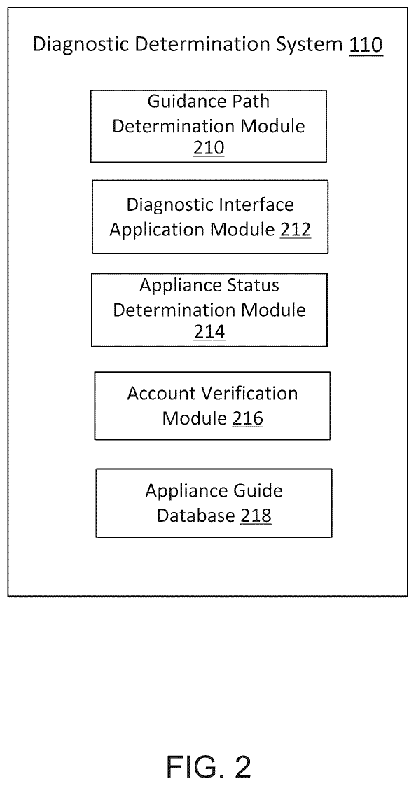

FIG. 2 shows example components of the diagnostic determination system 110 of FIG. 1. In the shown embodiment, the diagnostic determination system 110 includes a guidance path determination module 210, a diagnostic interface application module 212, an appliance status determination module 214, an account verification module 216, and an appliance guide database 218.

The guidance path determination module 210 includes programs and instructions to perform some or all the previously recited features. For example, the guidance path determination module 210 determines a guidance path based on received input. The guidance path may be determined based on received input from computing device 114 or a selected appliance guide. Further, the guidance path determination module 210 updates the determined guidance path based on received input. For example, the guidance path determination module 210 updates the guidance path to include an additional or different step for a diagnosis of an appliance. The guidance path determination module 210 also determines potential paths for progressing through one or more nodes that form the guidance path. Further, as the diagnostic determination system 110 progresses through each node, the potential paths are filtered so that they are narrowed down to fewer potential paths based on received input from the computing device 114. As more potential paths are filtered based on received input, the guidance path is complete with a final diagnostic. In some embodiments, the path from the beginning, which is the first node, to the end, which is the final diagnostic, forms the guidance path.

The diagnostic interface application module 212 includes programs for maintaining and executing the mobile diagnostic application. The diagnostic interface application module 212 may include application programming interfaces (APIs) to interface with other applications or other systems. Further, the diagnostic interface application module 212 is configured to communicate with the mobile diagnostic application to configure diagnostic interfaces to be displayed on a computing device, such as computing device 114. The diagnostic interface application module 212 is further configured to cause the computing device 114 to display a diagnostic interface. The diagnostic interface application module 212 also controls communications that include received input from the computing device 114. Once received, the diagnostic interface application module 212 may pass the received input to other modules for processing, such as the guidance path determination module 210.

The appliance status determination module 214 determines a status of the appliance or its included components. A status of the appliance indicates a presence of specified components and whether they are functioning. For example, a status may indicate whether a ground fault interrupter (GFI) is present and functioning properly. Other examples include whether a heating element is present and operating correctly. The appliance status determination module 214 receives input, either from the computing device 114 or being passed the information from the diagnostic interface application module 212 or another module that receives input and determines if the specified appliance includes a component.

Further, the appliance status determination module 214 determines the status of the present component including if the component is operating correctly. For example, received input may indicate that a cooktop is not functioning properly. Based on the cooktop being an electric cooktop, the appliance status determination module 214 determines that an electric heating element is present. The appliance status determination module 214 additionally determines that voltages and other electrical components need to be checked for a diagnosis of the electric cooktop. In some embodiments, the appliance status determination module 214 determines the status based on received input from the computing device 114.

The account verification module 216 receives user credentials and verifies that the indicated user has access to the diagnostic determination system 110. For example, a user may have purchased a license to use the diagnostic determination system 110. The user's credentials, such as a login and password, are added to a user database. Then, the user inputs their credentials into a mobile diagnostic application, which are communicated to the diagnostic determination system 110.

The account verification module 216 checks the user database for the credentials. If the credentials are present, then the user is given access to the diagnostic determination system 110 and its full capabilities. The user database may optionally be included with the diagnostic determination system 110 or stored on a separate system. Accordingly, the account verification module 216 validates accounts associated with users. In some embodiments, validating the accounts includes receiving credentials from the computing device 114 and determining the credentials match a user account stored in an account database.

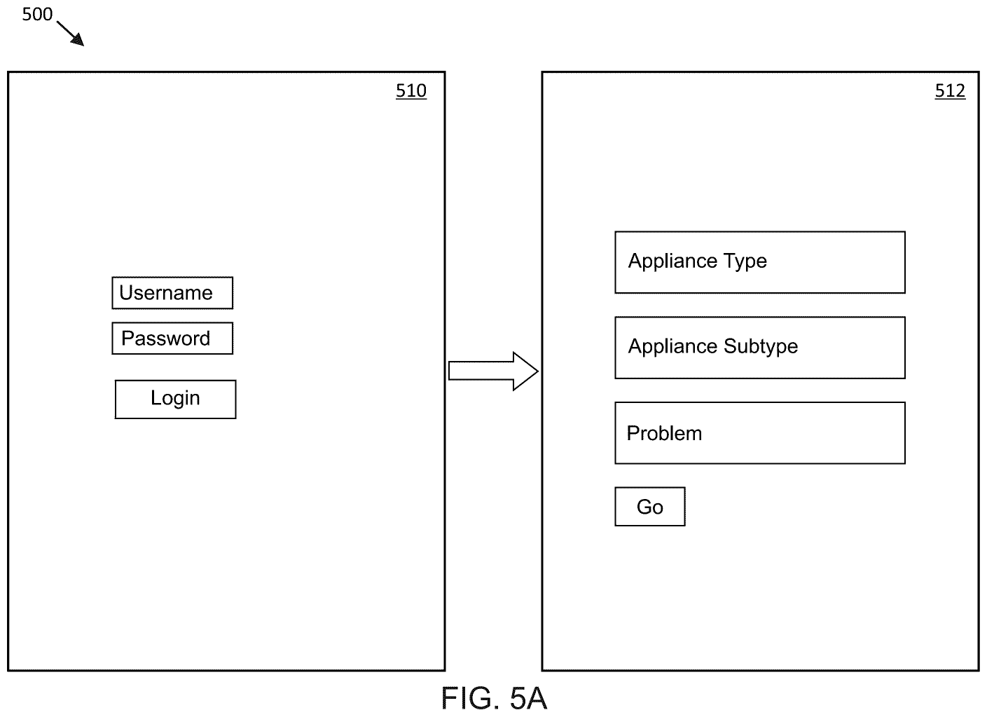

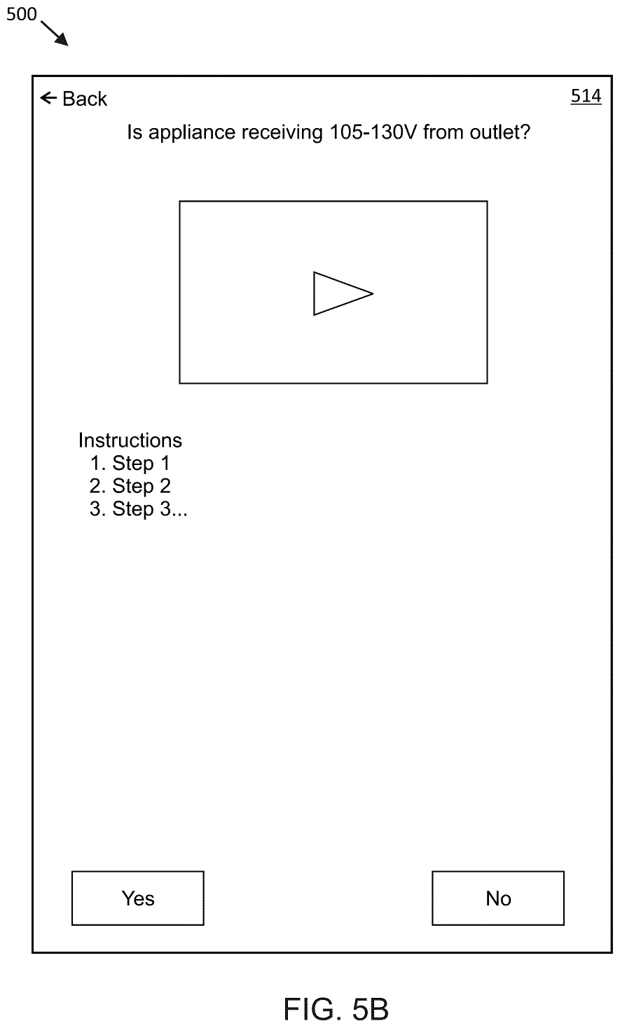

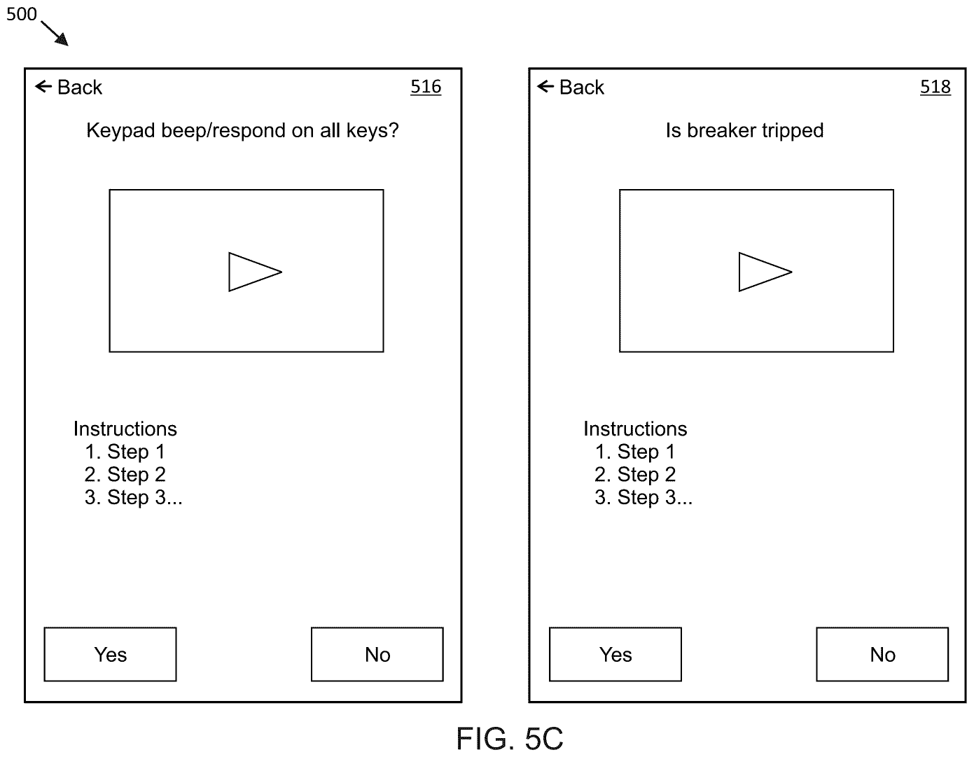

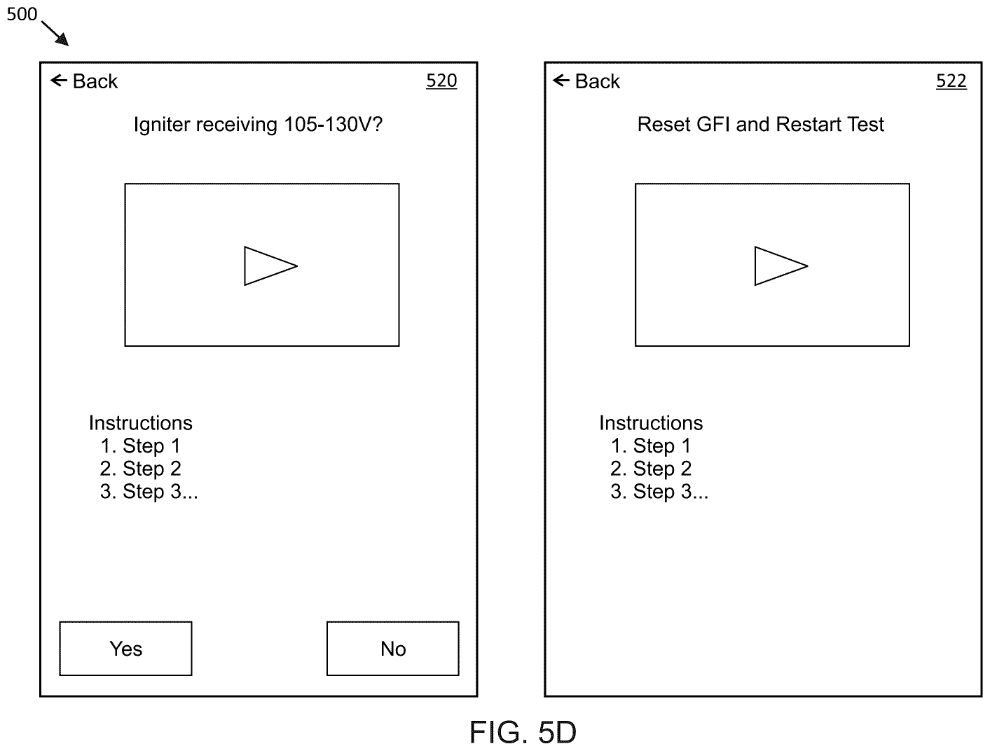

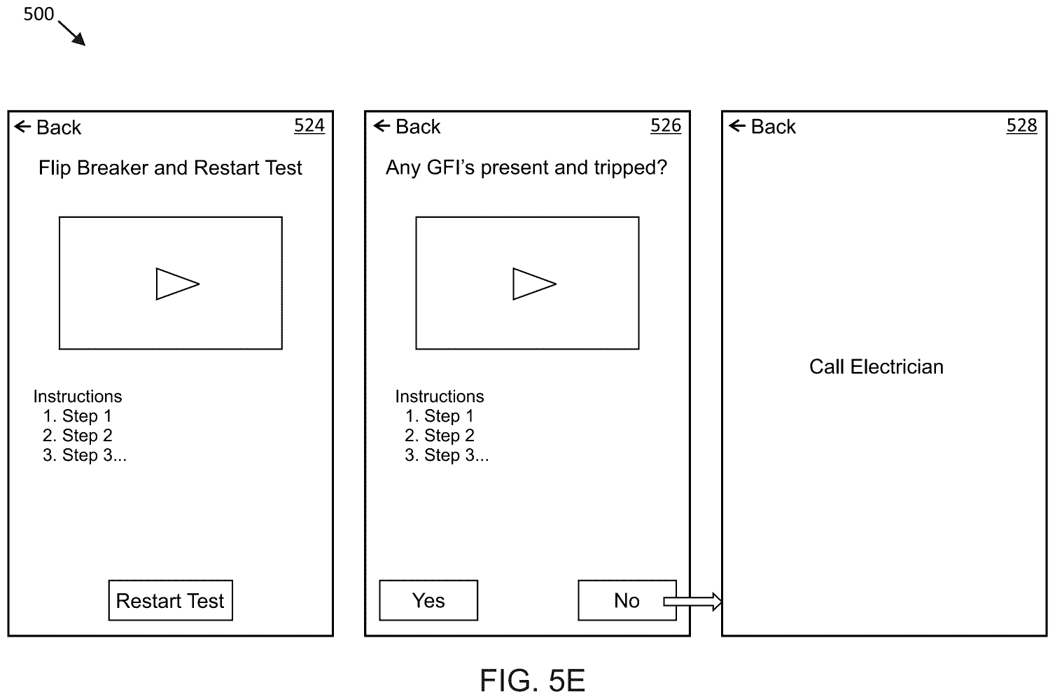

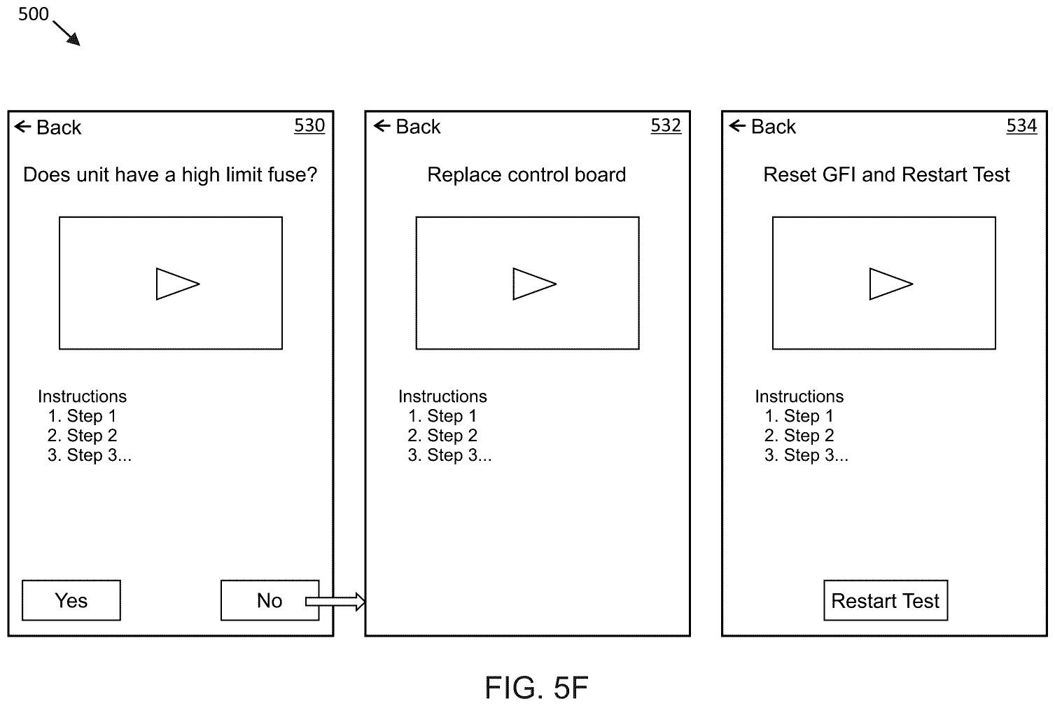

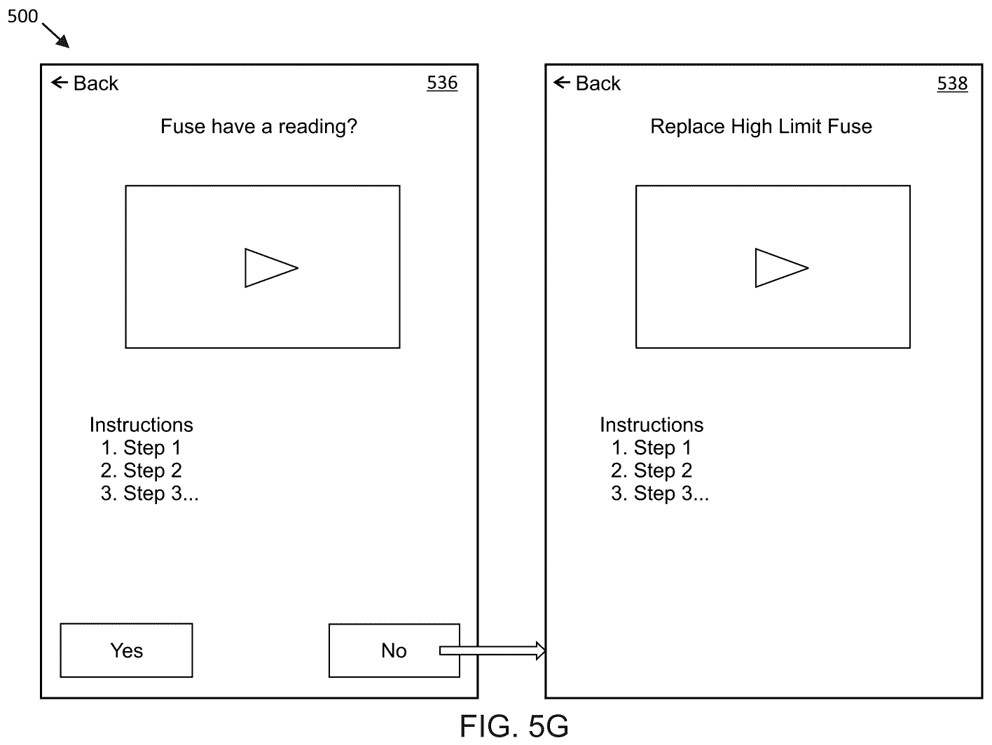

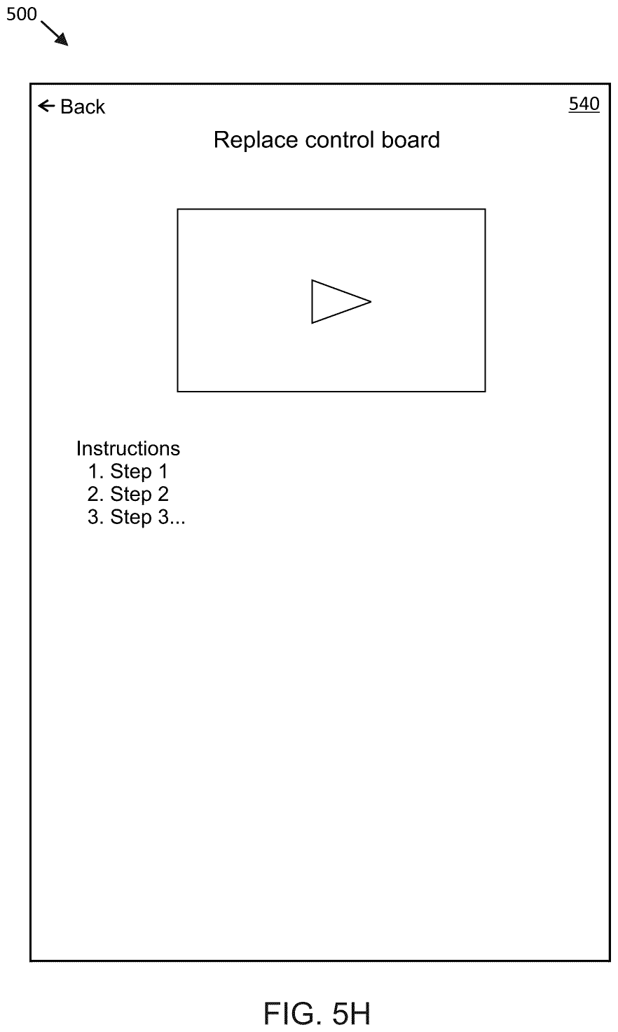

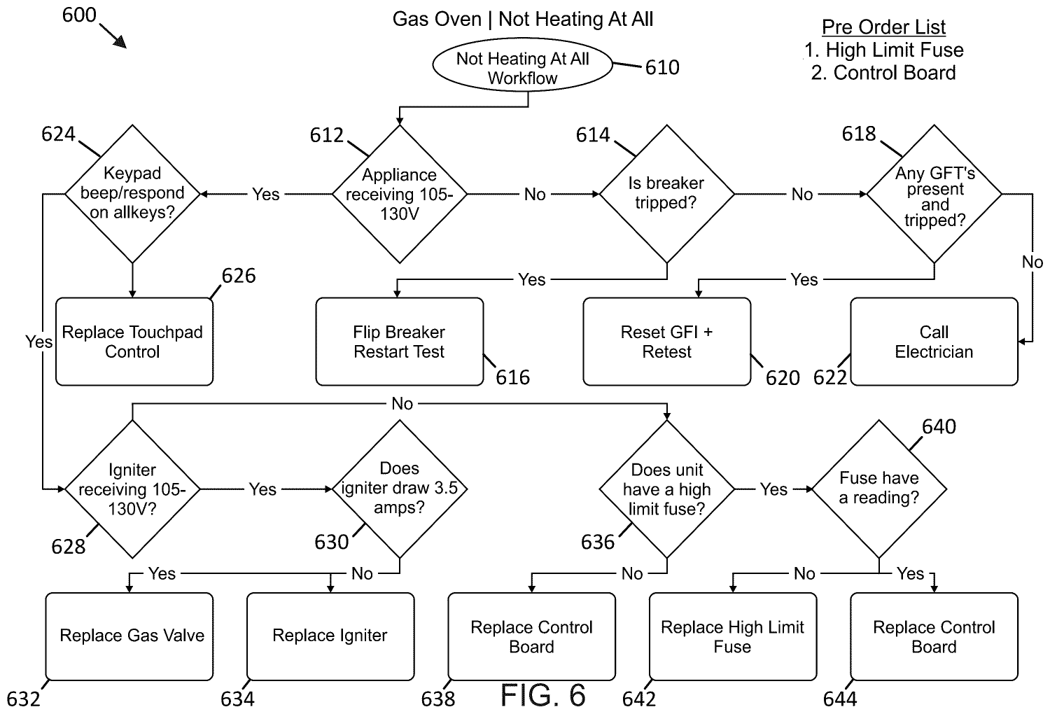

The appliance guide database 218 stores appliance guides for a plurality of appliances and appliance sub-types. These guides include many possible guide paths through the appliance guide to result in a diagnosis. The appliance guides are represented by the process flow diagrams shown in FIGS. 5A-6. In some embodiments, appliance guides are represented by other process flow diagrams. Many different types of appliance guides may be stored in the appliance guide database 218. Further, the appliance guides can be edited, deleted, or added to as appliances change through updates in technology or design changes.

Some or all of these modules may be combined or omitted in some embodiments. In some embodiments, one or more of the shown modules are used to perform methods or execute instructions that cause the diagnostic determination system 110 to perform a method as shown in FIG. 13.

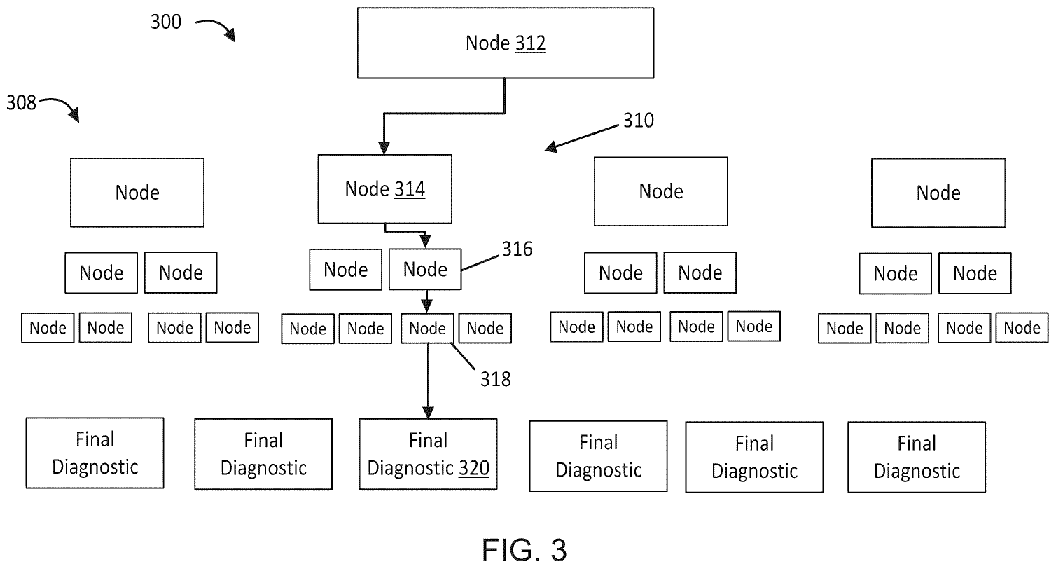

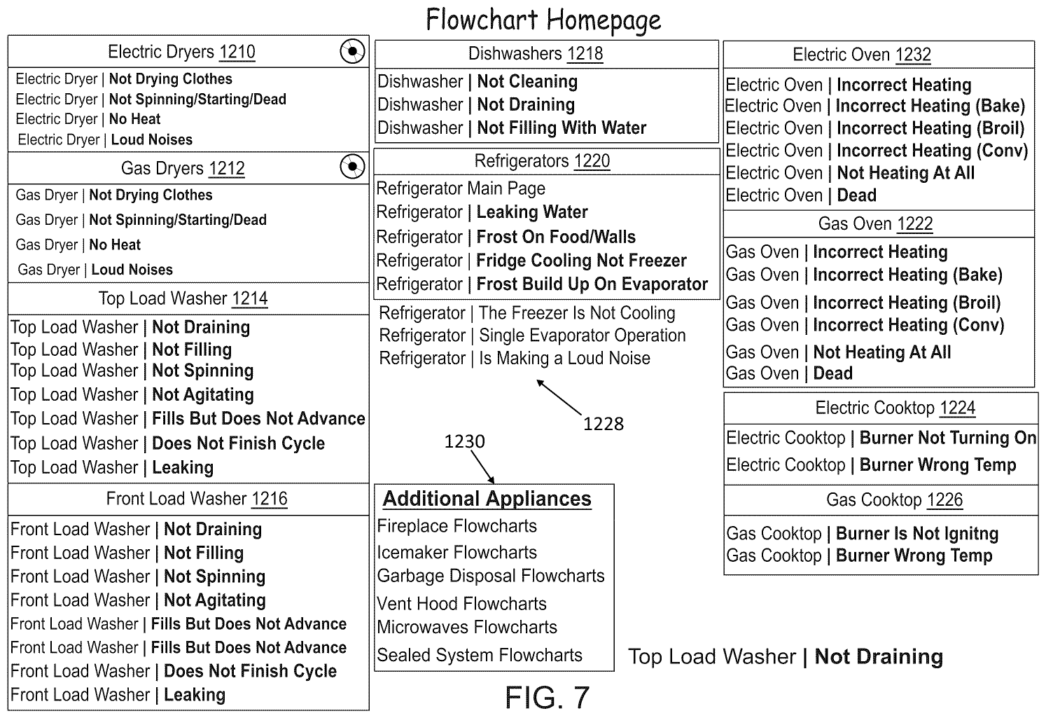

FIG. 3 shows an example appliance guide including guidance paths generated by the diagnostic determination system 110 of FIG. 1. An example appliance guide 300 includes a guidance path 310 and one or more nodes 308. The guidance path 310 connects from node 312 to node 314, node 316, node 318, and final diagnostic 320. Guidance paths are determined based on the shown appliance guides in FIG. 7.

The guidance path 310 is determined by the diagnostic determination system 110 is one of many possible guidance paths. In the shown embodiment, the appliance guide 300 is selected. The appliance guide 300 includes a plurality of nodes for progressing to a final diagnostic. Based on received input, the diagnostic determination system 110 selects the guidance path 310 to result in a final diagnostic 320.

In this embodiment, determining the guidance path 310 includes plotting a path through nodes 314, 316, 318, and then to final diagnostic 320. In some embodiments, the guidance path progresses through other nodes and can arrive at different final diagnostics. The guidance path 310 may be determined based on a single input from the computing device 114. In some embodiments, the guidance path continually receives input to plot a path to the next node, and also plot a path through additional subsequent nodes.

In addition, each of the shown nodes include an associated diagnostic interface. Information contained within the diagnostic interface provides guidance to diagnosing the appliance 118. The diagnostic interface may prompt for more input to further determine the guidance path 310. The final diagnostic includes a diagnosis of the appliance 118. Moreover, the final diagnostic may include steps to complete a repair of the appliance 118. Each node may have repair steps associated with the node and diagnostic interface as well.

In some embodiments, the shown guidance path includes branching paths. For example, the guidance path may include branching paths from node 314. A branching path is then selected based on received input. A first branching path is selected based on a condition of an appliance. In an example, the condition is an oven that is not heating at all. Based on this condition, the guidance path 310 proceeds from node 312 to node 314. Node 314 is the first branching path and includes an associated operation that depends on whether the oven is receiving proper voltage. A second branching path may include progressing to a node that depends on if the oven is heating incorrectly. The second branching path may then proceed to another node with an associated operation that depends on if the oven has a fan. Many different branching paths can be contemplated from the appliance guides described, herein. The guidance path 310 can provide specific diagnostic interfaces that are relevant to the issue of the appliance. Accordingly, a repair technician can avoid misdiagnosis by following the provided guidance path and ensure consistency in repairs.

In some embodiments, the appliance guide 300 can be updated to change the guidance path 310. The diagnostic determination system 110 can change the logic of the appliance guide 300. Changing the logic of the appliance guide 300 may include altering, rearranging, or otherwise editing the one or more nodes 308. For example, node 314 might be changed to connect to a different node than those shown. Further, the node 314 may be changed to connect to different nodes based on received input. The node 314 may also be altered to include different diagnostic interfaces than those shown. In some embodiments, the changes to the appliance guide 300 are pushed to computing device 114 through an API. The appliance guide can also be edited to increase the number of one or more nodes 308 or decrease the number of one or more nodes 308. For example, the one or more nodes 308 may include 500 nodes.

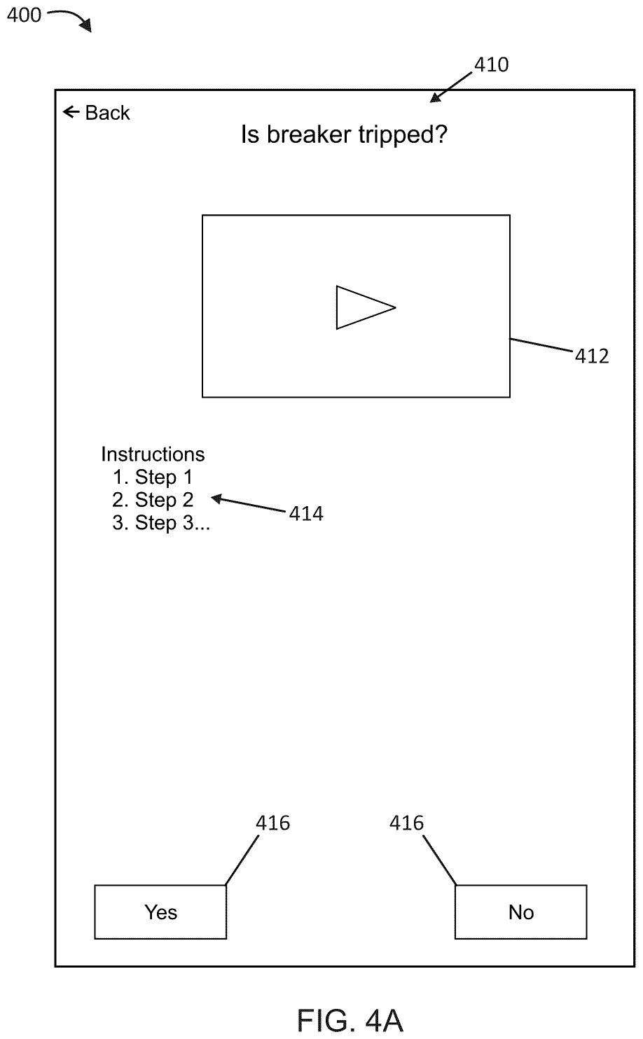

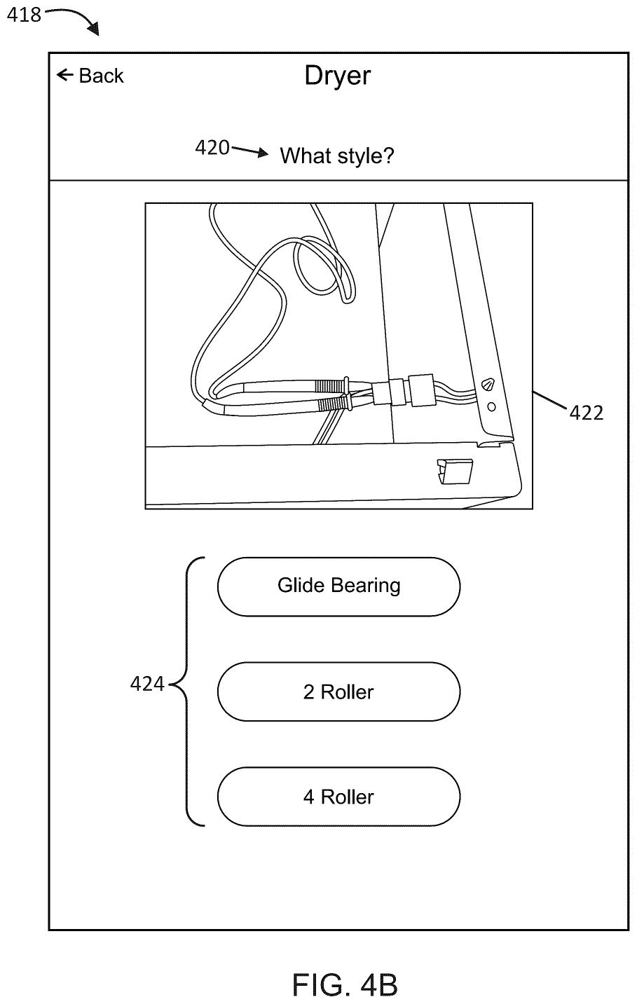

FIG. 4A shows an example diagnostic interface 400 associated with a guidance path. The diagnostic interface 400 includes a query 410, a video 412, instructions 414, and controls 416. In some examples, the diagnostic interfaces referred to herein are graphical user interfaces (GUIs).

The diagnostic interface 400 is configured to provide instructions 414 based on the query 410. The diagnostic interface 400 may be displayed on the computing device 114. Further, the mobile diagnostic application may be configured to display the diagnostic interface 400 responsive to receiving a signal from the diagnostic determination system 110. In this example, the query 410 asks if the breaker is tripped. Instructions 414 include steps to determine if the breaker is flipped. The instructions 414 may also include steps to repair. In addition, a video 412 shows another technician performing the steps of instructions 414 in real time. The video 412 may provide clarity on how to accomplish the instructions 414. Further, the video 412 may be displayed through an API connection to a third-party video content hosting service.

Based on completing the instructions 414, selection of one of the controls 416 is received. In this embodiment, the controls are “yes” and “no” buttons in response to query 410. In some embodiments, the controls 416 are a plurality of options that allow for customized feedback. For example, the controls 416 may be a text box that receives input that the diagnostic determination system 110 analyzes to determine a guidance path. Other examples may include a query 410 with further details regarding a component or other feature associated with the appliance. For example, the query 410 may ask if a component is present, a type of device, a sub-type of device or if a component is operational. In some embodiments, the diagnostic interface 400 includes a parts list to be ordered. In some embodiments, the diagnostic interface 400 includes warning icons. The warning icons may be displayed if the diagnostic interface 400 includes instructions relating to a hazardous condition. For example, the hazardous condition may be an electrical hazard, a sewer hazard, a water hazard, or a gas hazard. Further, the diagnostic interface 400 may include a display that indicates a technician should have an indicated license to complete the repair step, such as an electrician license or a plumber license.

The diagnostic interface 400 and associated features provide instructions 414 and the video 412 to assist a repair technician. The instructions 414 and video 412 provide detailed steps to successfully address the query 410. The correct input of controls 416 is then received. These components enable a repair technician to efficiently learn to diagnose an issue and increase accuracy in a determined diagnosis. For example, following the instructions 414 or watching the video 412 provides enough details for the technician to make correct selections of controls 416. Based on the received instructions, the diagnostic determination system 110 determines a diagnosis. The diagnosis from the diagnostic determination system 110 are consistent and accurate through the use of the discussed components.

FIG. 4B shows an additional example diagnostic interface generated by the diagnostic determination system 110 of FIG. 1. In the shown embodiment, diagnostic interface 418 includes query 420, image 422, and controls 424.

Similarly to the diagnostic interface 400, the diagnostic interface 418 includes a query 420. However, the query 420 poses a question that can receive more than just two types of inputs such as “yes” or “no.” Instead, the diagnostic interface 418 can receive input from controls 424. The controls 424 are a radio input style that a user can select one or more of the presented options. Based on the received input, the diagnostic determination system 110 determines a guidance path and provide a subsequent diagnostic interface. Further, the diagnostic interface 418 includes the image 422 as opposed to a video. The diagnostic interfaces provided by the diagnostic determination system 110 may include many types of instruction aids such as image 422 or video 412.

FIGS. 5A-5H show an example appliance guide 500 with associated diagnostic interfaces. The appliance guide 500 shows example diagnostic interfaces to provide guidance on repairing a specified appliance, which are similar to diagnostic interface 400. Interface 510 connects to interface 512. Interface 512 connects to interface 514. Interface 514 connects to interfaces 516 and interface 518. Interface 516 connects to interfaces 520 and interface 522. Interface 518 connects to interfaces 524 and interface 526. Interface 520 connects to interface 530. Interface 526 connects to interface 528 and interface 534. Interface 530 connects to interface 532 and interface 536. Interface 536 connects to interface 538 and interface 540. These interfaces illustrate the sequence associated with the appliance guide 500. The diagnostic determination system 110 determines a guidance path through the appliance guide 500, similar to the guidance path 310 of FIG. 3, to determine a diagnosis of an appliance.

In this embodiment, the appliance guide 500 begins with “oven” being the indicated type, “gas” being the indicated subtype, and “not working” being the indicated problem. As the diagnostic determination system 110 receives input, the diagnostic determination system 110 determines a guidance path. The diagnostic determination system 110 also provides diagnostic interfaces 510-540 associated with the determined guidance path. The diagnostic interfaces include instructions to aid with diagnosis. The determined guidance path ends with a final diagnostic that provides a diagnosis of the problem with the appliance. In some embodiments, the final diagnostic includes instructions to repair the appliance.

The provided diagnostic interface, which is the same or similar to diagnostic interface 400, begins with requesting login information in diagnostic interface 510. The system then requests an appliance type, appliance subtype, and a problem in diagnostic interface 512. The appliance guide 500 proceeds through a series of queries to assist with diagnosing or repairing the specified appliance in diagnostic interfaces 514-540.

For example, the diagnostic determination system 110 controls and provides the shown interfaces. The diagnostic determination system 110 provides an interface 514 with a query regarding the received voltage level of the appliance. If the diagnostic determination system 110 receives input indicating that the appliance is not receiving the indicated voltage levels (e.g., 105V-130V), then the diagnostic determination system 110 provides an additional interface 518 with a query regarding if the breaker is flipped. If input indicating that the breaker is not flipped is provided, then a third diagnostic interface 522 with a query regarding a ground fault interrupter (GFI) is provided. If input indicating that a GFI is present is provided, then a fourth diagnostic interface 534 is provided. The fourth diagnostic interface 534 includes title instructions instead of a query and other instructions to repair the appliance. Diagnostic interfaces 538, 540 may also be provided for appliance malfunctions involving a fuse reading.

The diagnostic determination system 110 is configured to determine a guidance path through the shown diagnostic interfaces as described. Many different guidance paths can be determined that plot a path through the diagnostic interfaces to arrive at a final diagnosis. Many different configurations of the diagnostic interfaces can be appreciated as applied to other appliance guides.

FIG. 6 shows an example appliance guide 600 for repairing a gas oven using the diagnostic determination system of FIG. 1. In the shown embodiment, the appliance guide 600 includes a series of operations or steps in the shown process flow diagram to assist with diagnosing a gas oven. Further, some of the shown operations 610-644 correspond to a diagnostic interface of appliance guide 500. Based on received input, the diagnostic determination system 110 determines a guidance path to lead to a final diagnostic for the appliance. In additional embodiments, each of the shown appliance guides in FIG. 7 are implemented through the diagnostic interface 400. These implementations include displaying the question or condition associated with the current operation and receiving input in response. For example, the appliance guides of FIG. 7 are implemented with associated diagnostic interfaces similarly to appliance guide 500.

In an example, the shown condition or question within each operation may be the query 410. Further, receiving a selection of one of the controls 416 progresses a determined guidance path to the next corresponding operation. Moreover, the diagnostic determination system 110 processes the received input through the diagnostic interfaces to determine the next operation of the guidance path. The diagnostic determination system 110 causes a computing device, such as computing device 114 to display the diagnostic interfaces associated with the current operation. Further, each of the shown operations may correspond to a node of appliance guide 300, and the diagnostic determination system 110 is configured to determine a guidance path through the operations (i.e., nodes).

In the shown embodiment, the appliance guide 600 begins at operation 610 for diagnosing a gas oven that is not heating at all. From there, a guidance path can be determined based on the shown operations. At operation 612, the diagnostic determination system provides the diagnostic interface 514 requesting input to determine if the appliance is receiving 105-130 voltage, which is a proper voltage for the appliance. If the appliance is determined to not be receiving proper voltage, then the diagnostic determination system 110 determines the guidance path including the next operation based on if the breaker is flipped at operation 614. Operation 614 corresponds to diagnostic interface 518. If the breaker is determined to be flipped based on received input, then operation 616 is performed, which includes providing the diagnostic interface 524 with instructions regarding a flip breaker restart test. If the breaker is not flipped, the guidance path proceeds to operation 618. At operation 618, the diagnostic determination system provides the diagnostic interface 526 with instructions to determine if any GFIs are present. If none are present, then the guidance path proceeds to operation 622, which includes providing the diagnostic interface 528 for calling an electrician. If a GFI is present and flipped, then the guidance path includes providing the diagnostic interface 534 including instructions for resetting and retesting the GFI at operation 620.

Returning to operation 612, if the appliance is receiving the proper voltage, then the guidance path proceeds to operation 624 to determine if the keypad responds for all keys. Operation 624 corresponds to diagnostic interface 516. If the keypad does not respond to all keys, the diagnostic determination system 110 provides the diagnostic interface 532 with instructions to replace the keypad at operation 626. Once determined the keypad is working properly, the guidance path moves to operation 628. The diagnostic determination system 110 then determines a path based on a determination of if the igniter is receiving the proper voltage at operation 628. The diagnostic interface 520 is provided in association with the operation 628. If the igniter is receiving the proper voltage, then the diagnostic determination system 110 determines the guidance path proceeds to operation 630 for determining if the igniter is drawing 3.5 amps. The operation 630 includes providing a diagnostic interface that includes instructions for determining if the igniter is drawing the proper current. If yes, then the diagnostic determination system 110 determines the guidance path proceeds to operation 632, which includes providing a corresponding diagnostic interface that includes instructions for replacing the gas valve at operation 632. Alternatively, the igniter is replaced if it is not receiving 3.5 amps at operation 634 according to an associated diagnostic interface.

Returning to operation 628, if the igniter is not receiving proper voltage, the diagnostic determination system 110 determines the guidance path proceeds to operation 636. At operation 636, the corresponding diagnostic interface 530 is provided that includes instructions for determining whether the unit has a high limit fuse. If the unit does have a high limit fuse, then whether the fuse has a reading is determined at operation 640 according to the provided diagnostic interface 536. If there is a reading, the control board is then replaced at operation 644 according to diagnostic interface 540. If there is no reading, then the diagnostic determination system 110 provides the diagnostic interface 538 including instructions to replace the high limit fuse at operation 642. Returning to operation 636, the guidance path proceeds to operation 644 if no high limit fuse is present.

Each of the discussed operations include associated diagnostic interfaces. In some embodiments, the associated diagnostic interfaces are the same or similar to the diagnostic interface 400. The diagnostic interfaces may include instructions for performing the indicated operation such as instructions 414. Further the diagnostic determination system 110 determines a path through the indicated operations based on received input. In some embodiments, the input is received through interaction with the controls 416. Further, each of the indicated final operations, such as operations 616, 620, 622, 632, 634, 638, 642, and 644 may include associated final diagnostics and instructions for completing a repair. Using the diagnostic determination system 110 to determine a guidance path through the shown operations improves appliance diagnosis accuracy and repair consistency.

FIG. 7 shows an example list 1200 of appliance guides that can be provided by diagnostic determination system 110. The shown list 1200 includes an electric dryer appliance guide 1210, a gas dryer appliance guide 1212, a top load washer appliance guide 1214, a front load washer appliance guide 1216, a dishwasher appliance guide 1218, a refrigerator appliance guide 1220, an electric oven appliance guide 1232, a gas oven appliance guide 1222, an electric cooktop appliance guide 1224, a gas cooktop appliance guide 1226, additional refrigerator appliance guides 1228, and additional appliance guides 1230.

In the shown embodiment, a plurality of different appliances and associated appliance guides are shown. These can be referred to as “homepages”. For example, the shown flowchart homepage includes front load washer appliance guide 1216 for diagnosing the indicated problem. Other appliance guides are divided based on a subtype. Top load washer appliance guide 1214 may be segmented into its own category. Additional appliance guides may also be included. For example, the diagnostic determination system 110 is configured to provide guides for diagnosing the appliances indicated within the additional appliance guides 1230. While certain types of appliance guides are shown, some embodiments include additional appliances not shown.

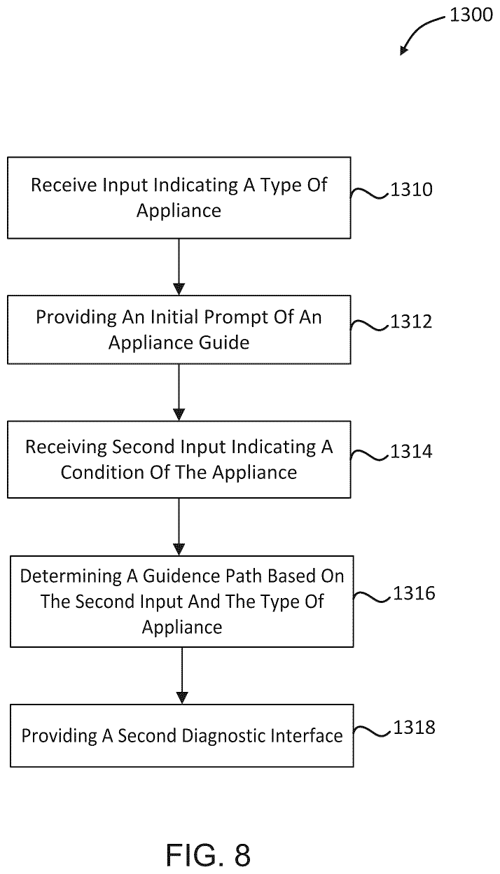

FIG. 8 shows a flowchart for an example method 1300 implemented on the diagnostic determination system 110 for determining a guidance path using the diagnostic determination system 110 of FIG. 1. In some examples, the method 1300 is initiated by the computing device 114.

At operation 1310, input indicating a type of an appliance is received. The input is received from a computing device. Further, the diagnostic determination system 110 receives the input from the computing device 114. In some embodiments, the initial input includes an appliance type, an appliance subtype, or an appliance issue.

At operation 1312, an initial prompt of an appliance guide is provided. In some embodiments, the initial prompt is provided to the computing device 114. The initial prompt is provided by the diagnostic determination system 110. The initial prompt is also determined based on received information such as the appliance type, subtype, or an indicated issue with the appliance. The initial prompt is also in the form of or similar to diagnostic interface 400. In other embodiments, the initial prompt takes a different form. The initial prompt requests additional input from the computing device 114 as well.

At operation 1314, input indicating a condition of the appliance is received from the computing device. The diagnostic determination system receives the input indicating the condition. The input may indicate that an appliance will not perform a specific function. For example, the appliance may be a washer that does not drain. The input may be selected from the flowchart homepage shown in FIG. 7.

At operation 1316, a guidance path based on the second input and the type of appliance is determined. The guidance path includes instructions to diagnose the appliance. Further, the guidance path includes one or more nodes that indicate steps for diagnosing the appliance based on the first input and the second input. Determining the guidance path also includes determining potential paths through the nodes. In addition, the diagnostic determination system 110 performs the determination. Based on the previously mentioned received input, a guidance path associated with an appliance guide is determined. This guidance path includes a determined path to guide to a diagnosis of the appliance based on received input from the computing device 114. In some embodiments, the guidance path is continually determined or updated as more input is received. Various diagnostic interfaces, such as diagnostic interface 400, are associated with the determined guidance path. Moreover, the guidance path also includes branching paths depending on the received input. In some embodiments, determining the guidance path includes selecting a branching path based on a determined condition of the appliance. In additional embodiments, the guidance path is retrieved from a guidance path database.

At operation 1318, a first diagnostic interface is provided to the computing device responsive to determining the guidance path. The first diagnostic interface is associated with the guidance path. In some embodiments, the first diagnostic interface is diagnostic interface 400 or any of the diagnostic interfaces shown in connection with the appliance guide 500. Further, additional diagnostic interfaces may be generated based on any of the discussed appliance guides in FIG. 7

In some embodiments, the method 1300 further includes receiving a third input from the computing device. The third input may indicate an additional status of the appliance. For example, the additional status indicates that a GFI is present and tripped. Further, the method 1300 may also include responsive to receiving the third input, determining a node of the one or more nodes based on the third response, filtering the potential paths of the guidance based on the node of the one or more nodes, and providing a second diagnostic interface to the computing device, the second diagnostic interface being associated with the node of the one or more nodes of the guidance path. A second diagnostic interface associated with the node is then provided to the computing device. The method 1300 may also include receiving additional input from the computing device indicating a status of the appliance. As previously explained, the status of the appliance indicates the presence of specified components and whether they are functioning. For example, a status may be that a GFI is present and flipped. In some embodiments, the method 1300 includes causing the computing device to display the first diagnostic interface. This operation is performed by the diagnostic determination system 110 and causes the computing device 114 to display the first diagnostic interface.

The method 1300 may include validating an account associated with a user. Validating the account includes receiving credentials and determining the credentials match a user account stored in an account database. In some embodiments, a final diagnostic interface is provided. The final diagnostic interface includes instructions to complete a repair of the appliance. Additionally, the final diagnostic interface includes a list of parts needed to complete the repair of the appliance.

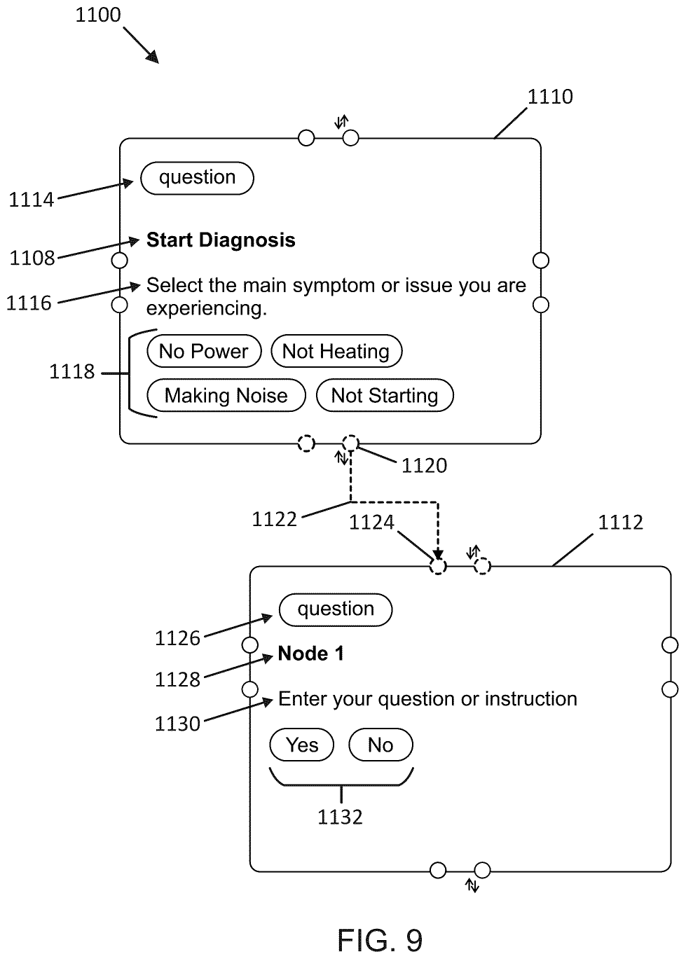

FIG. 9 shows an example user interface 1100 for a logic flow editor that allows for editing nodes and logic flows for an example appliance guide. These nodes can be used to build an appliance guide. For example, user interfaces can be built based on the start node 1110 and the node 1112 and their included information. Guidance paths then can be created to include various nodes of the appliance guide. The user interface 1100 illustrates a start node 1110 and a node 1112. The start node 1110 includes a question icon 1114 to begin the diagnosis. The question icon 1114 can be selected, and a number of options may display that can then be selected as the pop up that begins the diagnosis. For example, the start question requests what the device at issue is, such as a washer, dryer, oven, etc. In some embodiments, the question icon 1114 can receive a typed question.

The start node 1110 also includes an issue selection 1116. In the shown embodiment, the issue selection 1116 provides one or more symptoms 1118 displayed below. The one or more symptoms include no power, not heating, making noise, not starting. In some embodiments, the one or more symptoms 1118 include additional symptoms not shown. The one or more symptoms can be displayed in a user interface associated with the start node 1110 for selection by received input. In some embodiments, additional symptoms can be provided by typing or other methods to populate the issue selection 1116. In some embodiments, some of the one or more symptoms are presented in a user interface and used to populate the issue selection 1116 while others are hidden based on previously received input. In some embodiments, the start node 1110 includes additional components for filling out the node, such as instructional input. The start node 1110 also includes a start node name. The start node name indicates a type of appliance guide in some embodiments.

The start node 1110 also includes a logic point 1120 that connects through a connection 1122 to a logic point 1124 of the node 1112. Here, the logic point 1120 includes two different points that can connect to different nodes. Accordingly, the logic can proceed to different nodes based on the selected point of the logic point 1120. For example, if no power was selected based on received input, then the logic would flow through to the node 1112 based on the connection 1122 to the logic point 1124. In some embodiments, additional nodes can flow to the logic point 1124.

The node 1112 further includes a question icon 1126, a node name 1128, a question input 1130, and an input selection 1132. The question icon 1126 enables input of a question for the node 1112. For example, the question can be if the appliance turns on. The node 1112 can also be named. Naming the node 1112 based on the question or appliance guide can help for troubleshooting purposes of the appliance guides. In addition, instructions or additional questions can be provided by the question input 1130. In some embodiments, the question input includes instructions for determining the answer to the question icon 1126. In some embodiments, an additional question is provided. The input selection 1132 enables a selection of an appropriate response, such as “Yes” or “No” to the question icon 1126 or a question of the question input 1130. Based on the selected input of the input selection 1132, the logic flow proceeds to a different node that can be added.

The shown user interface 1100 shows how the editor can be used to change appliance guides. In an example, the start node 1110 and the node 1112 can be used to form an appliance guide. Based on the received input from a user, a guidance path is then determined that begins with the start node 1110 and proceeds to include the node 1112. In some embodiments, additional nodes can be added.

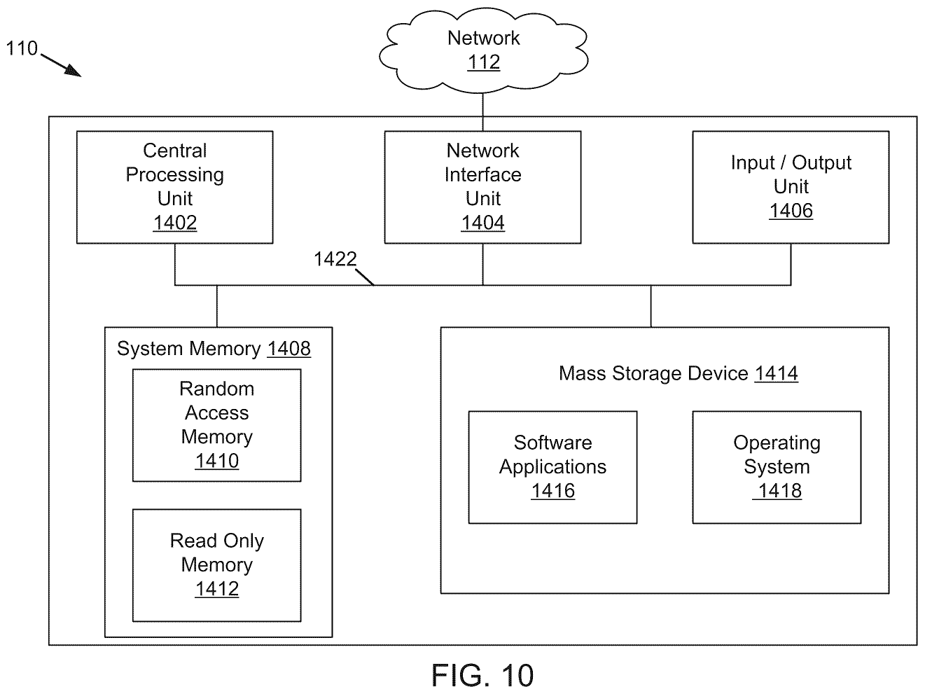

As illustrated in the example of FIG. 10, the diagnostic determination system 110 includes at least one central processing unit (“CPU”) 1402, also referred to as a processor, a system memory 1408, and a system bus 1422 that couples the system memory 1408 to the CPU 1402. The system memory 1408 includes a random-access memory (“RAM”) 1410 and a read-only memory (“ROM”) 1412. A basic input/output system that contains the basic routines that help to transfer information between elements within the diagnostic determination system 110, such as during startup, is stored in the ROM 1412. The diagnostic determination system 110 further includes a mass storage device 1414. The mass storage device 1414 is able to store software instructions and data. Some or all of the components of the diagnostic determination system 110 can also be included in computing device 114.

The mass storage device 1414 is connected to the CPU 1402 through a mass storage controller (not shown) connected to the system bus 1422. The mass storage device 1414 and its associated computer-readable data storage media provide non-volatile, non-transitory storage for the diagnostic determination system 110. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the diagnostic determination system 110 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the diagnostic determination system 110.

According to various embodiments of the invention, the diagnostic determination system 110 may operate in a networked environment using logical connections to remote network devices through the network 112, such as a wireless network, the Internet, or another type of network. The diagnostic determination system 110 may connect to the network 112 through a network interface unit 1404 connected to the system bus 1422. It should be appreciated that the network interface unit 1404 may also be utilized to connect to other types of networks and remote computing systems. The diagnostic determination system 110 also includes an input/output controller 1406 for receiving and processing input from a number of other devices, including a touch user interface display screen, or another type of input device. Similarly, the input/output controller 1406 may provide output to a touch user interface display screen or other type of output device.

As mentioned briefly above, the mass storage device 1414 and the RAM 1410 of the diagnostic determination system 110 can store software instructions and data. The software instructions include an operating system 1418 suitable for controlling the operation of the diagnostic determination system 110. The mass storage device 1414 and/or the RAM 1410 also store software instructions and software applications 1416, that when executed by the CPU 1402, cause the diagnostic determination system 110 to provide the functionality of the diagnostic determination system 110 discussed in this document. For example, the mass storage device 1414 and/or the RAM 1410 can store software instructions that, when executed by the CPU 1402, cause the diagnostic determination system 110 to display received data on the display screen of the diagnostic determination system 110.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for diagnosing an appliance, the method comprising:
receiving, from a computing device via a graphical user interface (GUI), a first input from a user selection indicating a type of the appliance;
providing an initial prompt of an appliance guide to the computing device;
receiving a second input from another user selection, indicating a condition of the appliance from the computing device;
determining, by a processor, a guidance path based on the second input and the type of the appliance, the guidance path including instructions to diagnose the appliance, the guidance path including one or more nodes that indicate steps for diagnosing the appliance based on the first input and the second input, wherein determining the guidance path includes determining potential paths through the nodes; and
responsive to determining the guidance path, providing a first diagnostic interface to the computing device, the first diagnostic interface being associated with the guidance path.

2. The method of claim 1, further comprising:
receiving a third input from the computing device; and
responsive to receiving the third input:
determining a node of the one or more nodes based on the third response;
filtering the potential paths of the guidance based on the node of the one or more nodes;
providing a second diagnostic interface to the computing device, the second diagnostic interface being associated with the node of the one or more nodes of the guidance path.

3. The method of claim 1, wherein the guidance path includes branching paths.

4. The method of claim 3, wherein a first branching path is selected based on the condition of the appliance.

5. The method of claim 1, further comprising:
receiving additional input from the computing device indicating a status of the appliance.

6. The method of claim 1, further comprising:
causing the computing device to display the first diagnostic interface.

7. The method of claim 1, further comprising:
retrieving the guidance path from a guidance path database.

8. The method of claim 1, further comprising:
validating an account associated with a user.

9. The method of claim 8, wherein validating the account includes:
receiving credentials; and
determining the credentials correspond to a user account stored in an account database.

10. The method of claim 1, further comprising:
providing a final diagnostic interface, the final diagnostic interface including instructions to complete a repair of the appliance.

11. The method of claim 10, wherein the final diagnostic interface includes a list of parts needed to complete the repair of the appliance.

12. An electronic computing system comprising:
a processor; and
system memory, the system memory including instructions which, when executed by the processor, cause the electronic computing system to:
receive, from a computing device, input indicating a type of an appliance;
provide an initial prompt of an appliance guide to the computing device;
receive second input indicating a condition of the appliance from the computing device;
determine a guidance path based on the second input and the type of the appliance, the guidance path including instructions to diagnose the appliance, the guidance path including one or more nodes that indicate steps for diagnosing the appliance based on the first input and the second input, wherein determine the guidance path includes determine potential paths through the nodes; and
responsive to a determination of the guidance path, provide a first diagnostic interface to the computing device, the first diagnostic interface being associated with the guidance path.

13. The electronic computing system of claim 12, wherein the instructions further cause the electronic computing system to:
receive third input from the computing device; and
responsive to receiving the third input:
determine a node of the one or more nodes based on the third response;
filter the potential paths of the guidance based on the node of the one or more nodes;
provide a second diagnostic interface to the computing device, the second diagnostic interface being associated with the node of the one or more nodes of the guidance path.

14. The electronic computing system of claim 12, wherein the guidance path includes branching paths depending on received input.

15. The electronic computing system of claim 14, wherein a first branching path is selected based on a determined condition of the appliance.

16. The electronic computing system of claim 12, wherein the instructions further cause the computing device to:
receive additional input from the computing device indicating a status of the appliance.

17. The electronic computing system of claim 12, wherein the instructions further cause the electronic computing system to:
cause the computing device to display the first diagnostic interface.

18. The electronic computing system of claim 12, wherein the instructions further cause the computing device to:
retrieve the guidance path from a guidance path database.

19. The electronic computing system of claim 12, wherein the instructions further cause the computing device to:
provide a final diagnostic interface to a user, the final diagnostic interface including instructions to complete a repair of the appliance.

20. A non-transitory computer readable medium having instructions stored thereon, the instructions causing one or more processors to perform:
receiving, from a computing device, a first input indicating a type of an appliance;
providing an initial prompt of an appliance guide to the computing device;
receiving a second input indicating a condition of the appliance from the computing device;
determining a guidance path based on the second input and the type of the appliance, the guidance path including instructions to diagnose the appliance, the guidance path including one or more nodes that indicate steps for diagnosing the appliance based on the first input and the second input, wherein determining the guidance path includes determining potential paths through the nodes;
responsive to determining the guidance path, providing a diagnostic interface to the computing device, the diagnostic interface being associated with the guidance path;
receiving a third input from the computing device;
responsive to receiving the third input, providing a second diagnostic interface to the computing device, the second diagnostic interface being associated with the guidance path; and
providing a final diagnostic interface to a user, the final diagnostic interface including instructions to complete a diagnosis or repair of the appliance.
